(19) United States
(12) Patent Application Publication
(10) Pub. No.: US 2016/0188482 A1
(43) Pub. Date: Jun. 30, 2016

(54) METHOD AND SYSTEM FOR DYNAMIC OPERATING OF THE MULTI-ATTRIBUTE MEMORY CACHE BASED ON THE DISTRIBUTED MEMORY INTEGRATION FRAMEWORK

(71) Applicant: Electronics and Telecommunications Research Institute, Daejeon (KR)

(72) Inventors: Gyu II Cha, Daejeon (KR); Young Ho Kim, Daejeon (KR); Shin Young Ahn, Daejeon (KR); Eun Ji Lim, Daejeon (KR)

(21) Appl. No.: 14/984,497

(22) Filed: Dec. 30, 2015

(30) Foreign Application Priority Data
Dec. 30, 2014 (KR) 10-2014-0194189

(51) Int. Cl. G06F 12/08; H04L 29/06; G06F 3/06; H04L 29/08

(52) U.S. Cl. CPC G06F 12/0895; H04L 67/2847; H04L 67/141; H04L 67/16; H04L 67/1097; H04L 67/42; G06F 3/061; G06F 3/0631; G06F 3/067; G06F 3/0647; G06F 12/0862; G06F 2212/602; G06F 2212/604

(57) ABSTRACT

Provided herein is a method for dynamic operating of a multi-attribute memory cache based on a distributed memory integration framework, the method including setting a predetermined memory area to be divided into a first area and a second area; in response to obtaining information from the cache client on a request for a service to transceive data regarding the predetermined file, determining a type of a function that the cache client requested; and in response to determining that the cache client requested a cache function, specifying the first area as an area to be used by the cache client for data transceiving regarding the predetermined file, and in response to determining that the cache client requested a storing function, specifying the second area as an area to be used by the cache client for data transceiving regarding the predetermined file.

### CROSS-REFERENCE TO RELATED APPLICATION

The present application claims priority to and the benefit of Korean patent application number 10-2014-0194189, filed on Dec. 30, 2014, the entire disclosure of which is incorporated herein in its entirety by reference.

### BACKGROUND

1. Field of Invention

Various embodiments of the present invention relate to a method and system for dynamic operating of a multi-attribute memory cache based on a distributed memory integration framework.

2. Description of Related Art

The background conventional technology for the present disclosure is the software distributed cache technology that uses a multi-attribute memory.

Generally, the software distributed cache technology is used for the purpose to provide a disk cache for acceleration of performance of a file system or to provide an object cache function for acceleration of approaching a database. RNACache of RNA Networks, SolidDB of IBM, or Memcached that is open software are technologies for providing a software distributed cache function.

Memcached is a technology for accelerating a dynamic DB-driven website, which uses a conventional LRU (Least Recently Used) caching method. This is a most widely used conventional software cache technology, with a main focus on improving reusability of cache data by using a limited memory area on an optimized basis. Most of the cache technologies use similar methods in operating a cache area to improve performance while overcoming spatial restrictions.

However, such a cache operating method has a disadvantage that in cases of temporary files with low reusability or that need not be stored permanently, advantages of performance improvement cannot be realized due to unnecessary cache system use loads.

### SUMMARY

Various embodiments of the present invention are directed to resolve all the aforementioned problems of the conventional technology, that is to provide a dynamic cache operating method and system capable of supporting multi-attributes.

According to a first technological aspect of the present disclosure, there is provided a dynamic operating method of a multi-attribute memory cache based on a distributed memory integration framework, the method including (a) setting a predetermined memory area to be divided into a first area and a second area; (b) in response to being connected to a cache client via a predetermined network, generating a session with the cache client; (c) in response to obtaining information from the cache client on a request for a service to transceive data regarding the predetermined file, determining a type of a function that the cache client requested with reference to attribute information of the predetermined file included in the information on the request; and (d) in response to determining that the cache client requested a cache function, specifying the first area as an area to be used by the cache client for data transceiving regarding the predetermined file, and in response to determining that the cache client requested a storing function, specifying the second area as an area to be used by the cache client for data transceiving regarding the predetermined file.

According to a second technological aspect of the present disclosure, there is provided a dynamic operating system of a multi-attribute memory cache based on a distributed memory integration framework, the system including a cache area manager configured to divide a predetermined memory area into a first area and a second area so that data may be managed according to attribute information of the data; and a data arrangement area specifier configured to, in response to obtaining information on a request to transceive data regarding a predetermined file from the cache client, determine a type of a function that the cache client requested, and in response to determining that the cache client requested a cache function, specify the first area as an area to be used by the cache client for data transceiving of the predetermined file, and in response to determining that the cache client requested a storing function, specify the second area as an area to be used by the cache client for data transceiving of the predetermined file.

According to the present disclosure, memory storage management of cache data may be written independently according to a bulk memory management system being used, thereby reducing dependency on a certain system in realizing a memory cache system.

Furthermore, according to the present disclosure, it is possible to divide cache metadata management from data storage management, and thus since a cache data server directly transceives a plurality of cache data at the same time through an RDMA method in performing the data storage management, it is possible to increase parallelism of processing.

Furthermore, according to the present disclosure, it is possible to selectively use a cache management method specified to multi-attribute cache area and a subject area, thereby further enabling high performance operation of a cache according to characteristics of application.

Furthermore, according to the present disclosure, in a case of a file that does not need to be stored permanently, an end storage position is limited to a temporary storage area of a memory cache system, thereby removing load of data management through a separate file system and improving performance of data approaching.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a view schematically illustrating a configuration of a dynamic operating system of a multi-attribute memory cache of a distributed memory integration framework according to an embodiment of the present disclosure;

FIG. 2 is a view illustrating in further detail a configuration of a multi-attribute memory cache system based on a distributed memory integration framework according to an embodiment of the present disclosure;

FIG. 3 is a view for explaining a multi-attribute cache management area according to an embodiment of the present disclosure; and

FIG. 4 is a view for explaining a configuration of a cache metadata server according to an embodiment of the present disclosure.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

Furthermore, ‘connected/accessed’ represents that one component is directly connected or accessed to another component or indirectly connected or accessed through another component.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

### EMBODIMENT OF THE PRESENT DISCLOSURE

Configuration of an Entirety of the System

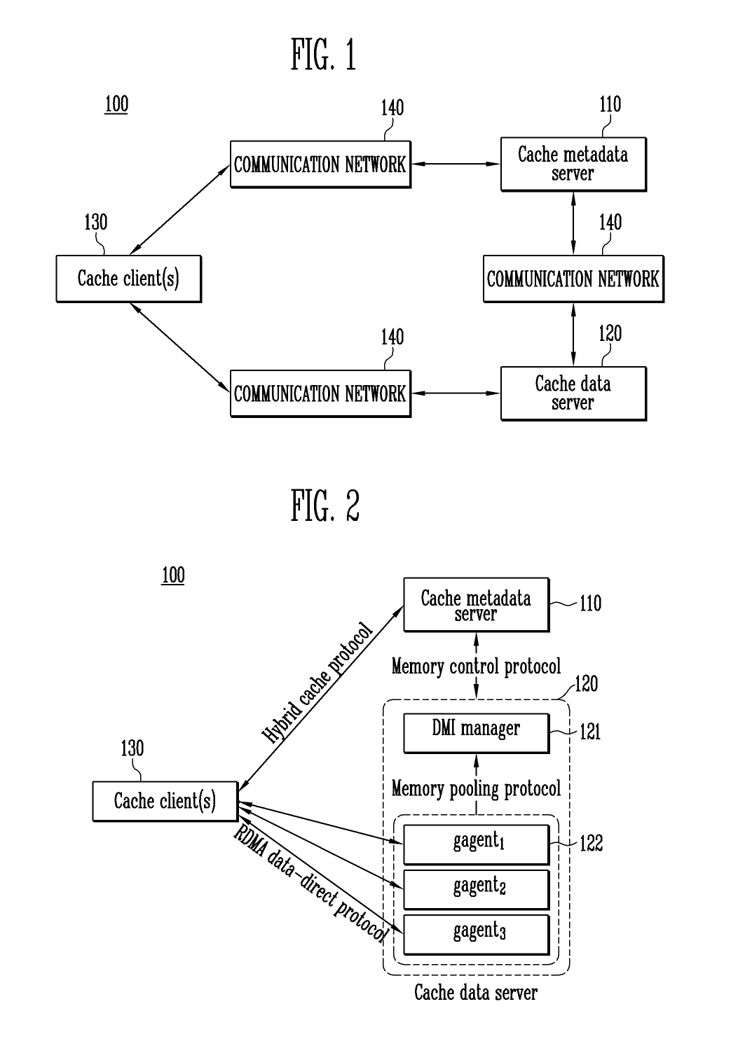

FIG. 1 is a view schematically illustrating a configuration of a dynamic operating system of a multi-attribute memory cache of a distributed memory integration framework according to an embodiment of the present disclosure.

As illustrated in FIG. 1, the entirety of the system 100 according to an embodiment of the present disclosure may include a cache metadata server 110, a cache data server 120, a cache client 130 and a communication network 140.

First of all, a communication network 140 according to an embodiment of the present disclosure may be configured regardless of the communication aspect of whether the communication is wireless or wired, and the communication network may be configured in one of various communication networks such as a LAN (Local Area Network), MAN (Metropolitan Area Network), and WAN (Wide Area Network) and the like. Desirably, the communication network 140 in the present disclosure may be the well known Internet. However, the communication network 140 may include at least a portion of a well known wired/wireless data communication network, well known telephone network, or well known wired/wireless television communication network.

Next, a cache metadata server 110 and cache data server 120 according to an embodiment of the present disclosure is one that forms a distributed memory integration framework, and the cache metadata server 110 may store and manage metadata that contains attribute information of a file, and store and manage information on the cache data server 120 where the data is stored.

Especially, the cache metadata server 110 may be provided with bulk virtual memory from the cache data server 120 that will be explained hereinafter and initiate use authority and track information that are necessary, and may perform a function of dividing a predetermined memory area (hereinafter referred to as multi-attribute cache area) necessary for distributed cache operating multi-attributes.

Furthermore, the cache metadata server 110 may perform a function of determining characteristics of data from data attribute information of a file and corresponding one area of among a plurality of areas provided in a multi-attribute cache area to the data according to the determined characteristics to transmit the information to the cache client 130.

Configuration and function of the cache metadata server 110 according to the present disclosure will be explained in further detail hereinafter. Furthermore, configuration and function of the multi-attribute cache area divided into a plurality of areas according to the present disclosure will be explained in further detail hereinafter as well.

The cache data server 120 according to an embodiment of the present disclosure stores data. More specifically, the cache data server 120 may be provided with a plurality of distributed memory (not illustrated) distributed and connected via a network, and the data may be distributed and stored in the plurality of distributed memory.

Configuration and function of the cache data server 120 according to the present disclosure will be explained in further detail hereinafter.

As the cache metadata server 110 and cache data server 120 according to the present disclosure are configured as a distributed memory integration framework, in the cache client 130, a route for approaching the metadata and the data of a file may be separated from each other. In order for the cache client 130 to approach the file, it is possible to approach the metadata of the file in the cache metadata server 110 first, and obtain information on the cache data server 120 where the data is stored, and then using that information, the cache information 130 may perform input/output of the data through parallel accesses with the plurality of distributed memories being managed by the cache data server 120, thereby improving the overall file access function.

Next, the cache client 130 according to an embodiment of the present disclosure is an apparatus that includes a function of communicating after accessing the cache metadata server 110 or cache data server 120. It may be a digital device provided with a memory means and a microprocessor, thereby having a computing capability. The cache client 130 may be a component that provides a substantial cache interface in the overall system 100.

When accessed to the cache metadata server 110 through the network, the cache client 130 requests the cache metadata server 110 for a cache client ID (identity or identification) for identifying itself. The accessing method of the cache metadata server 110 and cache client 130 are not limited, but the cache metadata server 110 may transmit a generated ID to the cache client 130, and thus a session may be established using the generated ID.

Meanwhile, herein, a session may mean an access activated between i) the cache metadata server 110 and cache client 130 or between ii) the cache data server 120 and cache client 130, and more particularly, a session may mean a period from a point where a logic connection is made and recognition of each other is made through data (message) exchange until a point where communication ends, for a dialogue between each other (for example, data transceiving, data request and response and the like).

Configuration of Cache Data Server

Hereinafter, internal configuration of the cache data server 120 according to the present disclosure and functions of each component thereof will be explained.

FIG. 2 is a view illustrating in detail the configuration of the cache data server 120 in the overall system 100 illustrated in FIG. 1.

First of all, in the overall system 100 of the present disclosure, the cache data server 120 may be configured as a bulk virtual memory server (DMI server, Distributed Memory Integration Server) for processing substantial storage of the cache data.

As illustrated in FIG. 2, the cache data server 120 configured as a bulk virtual memory server may include a DMI manager 121, distributed memory granting node (not illustrated) and granting agent 122.

The granting agent 122 may be executed in a plurality of distributed memory granting nodes, and perform a function of granting a distributed memory that will be subject to integration. More specifically, the granting agent 122 may obtain a local memory granted from a distributed memory granting node, and register the memory to the DMI manager 121 and perform pooling to the bulk virtual memory area, thereby granting the distributed memory.

Next, the DMI manager 121 may perform a function of integrating and managing the distributed memory. The DMI manager 121 may receive a request for registration from the plurality of granting agents 122, and configure and manage a distributed memory pool. In response to receiving a memory service request from the cache metadata server 110, the DMI manager 121 may allocate or release the distributed memory through the distributed memory pool, and track a use situation of the distributed memory. In response to receiving a request to allocate the distributed memory from the cache metadata server 110, the DMI manager 121 may allocate the memory, and the cache client 130 may communicate with the granting agent 122 where the allocated memory actually exists and transmit the data of the memory.

In such a case, communication between the cache client 130 and the granting agent 122 may be performed by an RDMA (Remote Direct Memory Access) protocol. That is, the granting agent 122 may directly process data transceiving with the cache client 130 through the RDMA protocol. The granting agent 122 may be allocated with the memory to be granted from a local memory, complete registration for using RDMA in its system, and register information on a subject space to the DMI manager 121 so as to be managed as a memory pool.

The RDMA protocol is a technology for performing data transmission between memories via a high speed network, and more particularly, the RDMA may directly transmit remote data from/to a memory without using the CPU. Furthermore, since the RDMA provides a direct data arrangement function as well, data copies may be eliminated thereby reducing CPU operations.

Configuration of Cache Metadata Server

Hereinafter, internal configuration of the cache metadata server 110 and functions of each component thereof will be explained.

FIG. 4 is a view for explaining a configuration of the cache metadata server 110 according to an embodiment of the present disclosure.

The cache metadata server 110 according to the embodiment of the present disclosure may be a digital apparatus provided with a memory means and a microprocessor, thereby having computing capabilities. As illustrated in FIG. 4, the cache metadata server 110 may include a cache area manager 111, data arrangement area specifier 113, communicator 117, database 119, and controller 115. According to an embodiment of the present disclosure, at least a portion of the cache area manager 111, data arrangement area specifier 113, communicator 117, database 119 and controller 115 may be a program module that communicates with the cache client 130 or cache data server 120. Such a program module may be included in the cache metadata server 110 in the format of an operating system, application program module, or other program module, and physically, it may be stored in one of various well known memory apparatuses. Furthermore, such a program module may be stored in a remote memory apparatus communicable with the cache metadata server 110. Meanwhile, such a program module includes a routine, subroutine, program, object, component, and data structure that will be explained hereinafter configured to perform a certain task or to execute certain abstract data, but without limitation.

First of all, the cache area manager 111 according to an embodiment of the present disclosure may perform a function of dividing a predetermined memory area, that is a multi-attribute cache area into a first area and a second area so that cache data may be managed according to the attribute information of the cache data requested by the cache client 130.

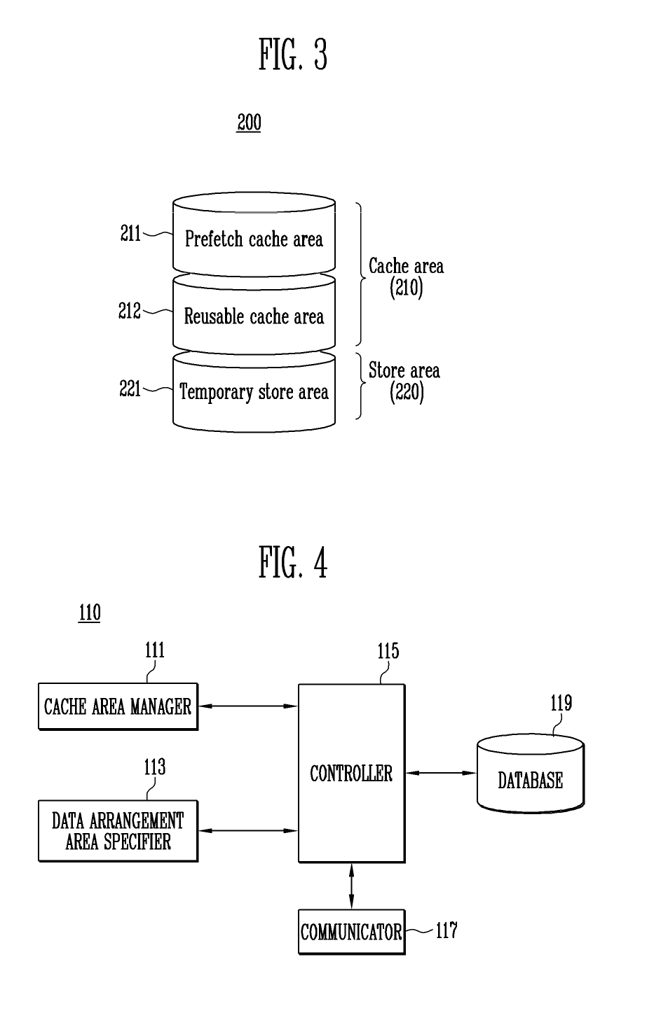

Hereinafter, a multi-attribute cache area divided into a plurality of areas by the cache area manager 111 and a method for managing the multi-attribute cache area will be explained in detail with reference to FIG. 3.

FIG. 3 is a view for explaining a configuration of a multi-attribute cache management area according to an embodiment of the present disclosure.

As aforementioned, when the cache metadata server 110 is being initiated by the cache area manager 111, the multi-attribute cache area 200 may be largely divided into a first area 210 and a second area 220. The first area 210 may be a cache area, and the second area 220 may be a storage area, and the first area 210 may be further divided into a prefetch cache area 211 and a reusable cache area 212, while the second area may include a temporary storage area 221. These three areas may be initiated to predetermined default values.

The temporary storage area 221 is for data that does not need to be permanently stored, or one-time data, or data of which the possibility of being reused is or less than a predetermined value, and this may be to determine that in a case where the data of the file requested by the cache client 130 satisfies the aforementioned condition, the data need not be stored in the cache area, and to limit its end storage position to the temporary storage area 221.

Meanwhile, in a case where it is determined that the multi-attribute cache area 200 needs to be changed in order to increase performance of the overall system 100 in the cache process by the cache client 130, the cache area manager 111 may perform a function of dynamically changing a relative size of the plurality of areas that form the multi-attribute cache area 200.

For example, in the cache process by the cache client 130, in a case where there is more request for data for using the first area 210 than the data for using the second area 220, it is possible to make changes such that the size of the first area 210 is greater than the second area 220. Furthermore, in the first area 210, in a case where there is more request for data for using the reusable cache area 212 than the data for using the prefetch cache area 211, it is of course possible to make changes such that the size of the reusable cache area 212 is greater than the prefetch catch area 211.

Furthermore, the cache area manager 111 may perform a function of refreshing the cache area in order to secure available cache capacity. This process is performed asynchronously, and a different method may be used depending on the type of the multi-attribute cache area 200.

More specifically, the prefetch cache area 211 uses a circulative refresh method, and since an additional change block is not allowed in the prefetch area 211, when the circulative refresh method is being executed, an additional change block writing process may not be performed.

The reusable cache area 212 uses an LRU (Least Recently Used) refresh method, and since the reusable cache area 212 allows an additional change block, a block where a changed cache data exists is excluded at a step where the LRU refresh method is executed, and may be refreshed after actually being written in a file storage by an additional asynchronous process. Meanwhile, in the caching method of the present disclosure, the circulative refresh method and LRU refresh method are obvious tasks for those skilled in the art, and thus detailed explanation thereof will be omitted herein.

Next, when information on a request for a data transceiving service regarding a predetermined file is obtained from the cache client 130, the data arrangement area specifier 113 according to an embodiment of the present disclosure may determine a type of the function requested by the cache client 130 with reference to the predetermined file attribute information included in the information on the request, and the data arrangement area specifier 113 may perform a function of specifying the first area 210 as an area to be used by the cache client 130 for data transceiving regarding the predetermined file if it is determined that the cache client 130 requested a cache function, and specifying the second area 220 as an area to be used by the cache client 130 for data transceiving regarding the predetermined file if it is determined that the cache client 130 requested a storing function.

According to the present disclosure, the cache client 130 may use two operating modes, one of which being a cache function and the other being a temporary storing function. In order to use one of these two modes, the cache client 130 may request the cache metadata server 110 to generate a file management handle regarding the file for which the request for service has been made. When the information on the request is obtained, the data arrangement area specifier 113 may generate the file management handle corresponding to the subject cache client ID and transmit that information to the cache client 130.

Meanwhile, in the present disclosure, a file management handle may be a unique ID granted for identifying each file. It may be generation of metadata information on a file to be managed performed for the purpose for the cache client 130 intending to receive the cache service to have the distributed cache regarding the file subject to the service managed.

In the information that the data arrangement area specifier 113 transmits to the cache client 130, arrangement information on the data regarding the file subject to the service request (that is, information on whether the area to be used by the cache client 130 for transceiving data regarding the file subject to the service request is the first area 210 or second area 220, or more specifically, the prefetch cache area 211, reusable cache area 212 or temporary storage area 221 of among the multi-attribute cache areas), and information on the file management handle may be included. More specifically, after the management handle of the file subject to cache is generated, the cache client 130 may generate an arrangement map within a certain cache area of the cache data necessary for transceiving data directly from/to the cache data server 120, thereby providing information on the map to the cache client 130 as arrangement information of the data regarding the file subject to the service request.

Herein, the data arrangement area specifier 113 may determine whether the mode requested by the cache client 130 is a cache mode or a temporary storage mode based on the data attribute information of the file subject to the service request, and in response to determining the mode as being a cache mode, the data arrangement area specifier 113 may specify the first area 210, and in response to determining the mode as being a temporary storage mode, the data arrangement area specifier 113 may specify the second area 220. In response to determining that a cache mode has been requested, the data arrangement area specifier 113 may have a default value of having the reusable cache area 212 as the specified area, and in a subsequent operating process, a change may be made such that the specified area can be rearranged from the reusable cache area 212 to the prefetch cache area 211 in response to the attribute information on the data of the file subject to the service request showing low locality and high accessing continuity (for example, streaming data).

The cache client 130 may establish a session with the cache data server 110 with reference to the cache data arrangement information obtained from the cache metadata server 110, and more specifically, establish a session with the granting agent 122 of the cache data server 120. This may be a process of setting connections to directly transceive data to/from the cache data server 120 by the RDMA protocol. Meanwhile, the process of generating a session between the cache client 130 and cache data server 120 is similar to the aforementioned process of generating a session, except that the cache client ID to be used when establishing the session may not be newly generated, but instead, a unique value obtained from the cache metadata server 110 may be used.

Furthermore, when a session with the cache data server 120 is generated, the cache client 130 may perform data transceiving directly without additional intervention of the cache metadata server 110. However, regarding the cache client 130 storing or extracting cache data in a certain area allocated for the file data subject to the service request, in a case where the plurality of cache clients 130 perform a plurality of reading/writing under a management handle of a same subject file, a simultaneous reading ownership is guaranteed to the plurality of cache clients 130, but in a case of writing, an operation may be made to limit the ownership to only a certain cache client 130 that performs the operation.

Next, in the database 119 according to an embodiment of the present disclosure, various information such as information on a predetermined condition for managing a multi-attribute cache area, information on a certain arrangement condition corresponding to the data requested from the cache client, information on IDs on the plurality of cache clients, information on the cache data server, and information on metadata and the like may be stored. Although it is illustrated in FIG. 4, that the database 119 is included in the cache metadata server 110, depending on the necessity of one skilled in the art who realizes the present disclosure, the database 119 may be configured separately from the cache metadata server 110. Meanwhile, in the present disclosure, the database 119 is a concept that includes a computer readable record medium. The database 119 may be a database in a narrow sense or a database in a broad sense that includes data records based on a file system. And even a simple collection of logs, as long as the logs may be searched and data may be extracted therefrom, the database may be used as the database 119 of the present disclosure.

Next, the communicator 117 according to an embodiment of the present disclosure may perform a function enabling data transceiving to/from the cache area manager, data arrangement area specifier, and database. Furthermore, the communicator 117 may enable the cache metadata server to perform data transceiving with the cache client or cache data server.

Lastly, the controller 115 according to an embodiment of the present disclosure may perform a function of controlling data flow between the cache area manager 111, data arrangement area specifier 113, communicator 117, and database 119. That is, the controller 115 according to the present disclosure may control data flow to/from outside the cache metadata server 110 or control data flow between each component of the cache metadata server 110, thereby controlling the cache area manager 111, data arrangement area specifier 113, communicator 117, and database 119 to perform their unique functions.

Meanwhile, the present disclosure is based on an assumption that the cache data server is a DMIf (Distributed Memory Integration framework) where a granting agent is provided, but there is no limitation thereto, and thus, as long as it is a server that performs a distributed memory integration function, it may be used as the cache data server of the present disclosure.

The aforementioned embodiments of the present disclosure may be realized in the form of program commands that may be performed through various computer components and be recorded in a computer readable record medium. The computer readable record medium may include a program command, data file, and data structure solely or in combination thereof. A program command that may be recorded in the computer readable record medium may be one that is specially designed and configured for the present disclosure or one that is well known to one skilled in the computer software field and thus usable. Examples of computer readable record medium include a magnetic medium such as a hard disk, floppy disk and magnetic tape, an optic record medium such as a CD-ROM and DVD, a magneto-optical medium such as a floptical disk, and a hardware apparatus specially configured to store and perform a program command such as a ROM, RAM and flash memory and the like. Examples of program commands include not only mechanical codes such as those made by compilers, but also high tech language codes that may be executed by a computer using an interpreter and the like. The hardware apparatus may be configured to operate as one or more software modules configured to perform processes according to the present disclosure, and vice versa.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A dynamic operating method of a multi-attribute memory cache based on a distributed memory integration framework, the method comprising:
(a) setting a predetermined memory area to be divided into a first area and a second area;
(b) in response to being connected to a cache client via a predetermined network, generating a session with the cache client;
(c) in response to obtaining information from the cache client on a request for a service to transceive data regarding the predetermined file, determining a type of a function that the cache client requested with reference to attribute information of the predetermined file included in the information on the request; and
(d) in response to determining that the cache client requested a cache function, specifying the first area as an area to be used by the cache client for data transceiving regarding the predetermined file, and in response to determining that the cache client requested a storing function, specifying the second area as an area to be used by the cache client for data transceiving regarding the predetermined file.

2. The method according to claim 1,
further comprising:
(e) providing the cache client with information on the specified area so that the cache client transmits data of the predetermined file to a cache data server or obtains data of the predetermined file from the cache data server.

3. The method according to claim 1,
wherein at step (a), the first area is divided into a prefetch cache area and a reusable cache area.

4. The method according to claim 3,
wherein at step (d), in response to determining that the cache client requested a cache function, specifying the reusable cache area of the first area as an area to be used by the cache client for data transceiving regarding the predetermined file.

5. The method according to claim 4,
further comprising:
(d1) in response to data characteristics of the predetermined file satisfying a predetermined condition, changing an area to be used by the cache client for data transmitting or receiving regarding the predetermined file from the reusable cache area to the prefetch cache area.

6. The method according to claim 1,
further comprising:
(f) re-dividing the first area and the second area with reference to a ratio in which the first area and the second area are specified.

7. A dynamic operating system of a multi-attribute memory cache based on a distributed memory integration framework, the system comprising:
a cache area manager configured to divide a predetermined memory area into a first area and a second area so that data may be managed according to attribute information of the data; and
a data arrangement area specifier configured to, in response to obtaining information on a request to transceive data regarding a predetermined file from the cache client, determine a type of a function that the cache client requested, and in response to determining that the cache client requested a cache function, specify the first area as an area to be used by the cache client for data transceiving of the predetermined file, and in response to determining that the cache client requested a storing function, specify the second area as an area to be used by the cache client for data transceiving of the predetermined file.

8. The system according to claim 7,
wherein the cache area manager divides the first area into a prefetch cache area and a reusable cache area.

9. The system according to claim 8,
wherein the cache area manager controls the prefetch cache area to be operated by a circulative refresh method, and controls the reusable cache area to be operated by an LRU (Least Recently Used) caching method.

10. The system according to claim 7,
wherein when dividing the predetermined memory area initially, the cache area manager sets a ratio of the second area to the first area to a predetermined ratio, and re-divides the predetermined memory area with reference to a number of times the first area or the second area is specified.

11. The system according to claim 7,
wherein, in response to determining that the predetermined file is a temporary file or a possibility that the predetermined file will be reused is or less than a predetermined criteria based on the predetermined file attribute information included in the information on the request, the data arrangement area specifier determines that a type of a function that the cache client requested is a storage function.
